(19) United States
(12) Patent Application Publication
(10) Pub. No.: US 2006/0265849 A1
(43) Pub. Date: Nov. 30, 2006

(54) Valve cap removal system

(76) Inventor: Barry R. Youngs, Bayview, ID (US)

Correspondence Address: NEUSTEL LAW OFFICES, LTD., 2534 SOUTH UNIVERSITY DRIVE, SUITE 4, FARGO, ND, 58103, US

(21) Appl. No.: 11/142,143

(22) Filed: May 31, 2005

(51) Int. Cl. B23P 19/04

(52) U.S. Cl. 29/267

(57) ABSTRACT

A valve cap removal system for efficiently removing a utility valve cap. The valve cap removal system includes a base, a fixed jaw extending from the base, a lever member pivotally attached to the base, and a lower jaw extending from the lever member. The fixed jaw and the lower jaw are formed to fit within pivot holes in the perimeter of a utility valve cap. When the lever member is manipulated, the lower jaw is drawn towards the fixed jaw thereby engaging the valve cap between thereof. The continued upward movement of the lever member results in the valve cap being removed from a valve housing.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to tools for removing utility valve caps and more specifically it relates to a valve cap removal system for efficiently removing a utility valve cap.

2. Description of the Related Art

Any discussion of the prior art throughout the specification should in no way be considered as an admission that such prior art is widely known or forms part of common general knowledge in the field.

Utility valve caps are generally positioned flush within a housing for allowing selective access to a valve within the housing (e.g. water valves, sewer pipe, survey monument covers, fire valve shutoffs, etc.). The valve caps usually are circular and have a pair of pivot holes on the outer perimeter thereof to allow for a user to extend a bar member into and pry upwardly in a pivoting manner with respect to the housing. Once a portion of the valve cap is lifted above the housing, the user then simultaneously grasps the valve cap with their other hand for complete removal thereof.

While these devices may be suitable for the particular purpose to which they address, they are not as suitable for efficiently removing a utility valve cap. Conventional valve cap removal devices are cumbersome and require two hands to operate.

In these respects, the valve cap removal system according to the present invention substantially departs from the conventional concepts and designs of the prior art, and in so doing provides an apparatus primarily developed for the purpose of efficiently removing a utility valve cap.

### BRIEF SUMMARY OF THE INVENTION

In view of the foregoing disadvantages inherent in the known types of tools for removing valve caps now present in the prior art, the present invention provides a new valve cap removal system construction wherein the same can be utilized for efficiently removing a utility valve cap.

The general purpose of the present invention, which will be described subsequently in greater detail, is to provide a new valve cap removal system that has many of the advantages of the valve cap removal devices mentioned heretofore and many novel features that result in a new valve cap removal system which is not anticipated, rendered obvious, suggested, or even implied by any of the prior art valve cap removal devices, either alone or in any combination thereof.

To attain this, the present invention generally comprises a base, a fixed jaw extending from the base, a lever member pivotally attached to the base, and a lower jaw extending from the lever member. The fixed jaw and the lower jaw are formed to fit within pivot holes in the perimeter of a utility valve cap. When the lever member is manipulated, the lower jaw is drawn towards the fixed jaw thereby engaging the valve cap between thereof. The continued upward movement of the lever member results in the valve cap being removed from a valve housing.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a valve cap removal system that will overcome the shortcomings of the prior art devices.

A second object is to provide a valve cap removal system for efficiently removing a utility valve cap.

Another object is to provide a valve cap removal system that only requires one hand of a user to remove a utility cap.

An additional object is to provide a valve cap removal system that is capable of removing various types and sizes of utility caps.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention illustrating the lever member positioned within an inner attachment aperture for a smaller sized valve cap.

FIG. 3 is an exploded upper perspective view of the components of the present invention.

FIG. 4 is an upper perspective view of the present invention positioned above a valve cap to be removed.

FIG. 5 is an upper perspective view of the present invention with the lower jaw and the fixed jaw engaged within the pivot holes of the valve cover.

FIG. 6 is an upper perspective view of the present invention lifting a valve cap from the housing.

FIG. 7 is a side view of the present invention positioned above a valve cap to be removed.

FIG. 8 is a side view of the present invention with the lower jaw and the fixed jaw engaged within the pivot holes of the valve cover.

FIG. 9 is a side view of the present invention lifting a valve cap from the housing.

### DETAILED DESCRIPTION OF THE INVENTION

A. Overview

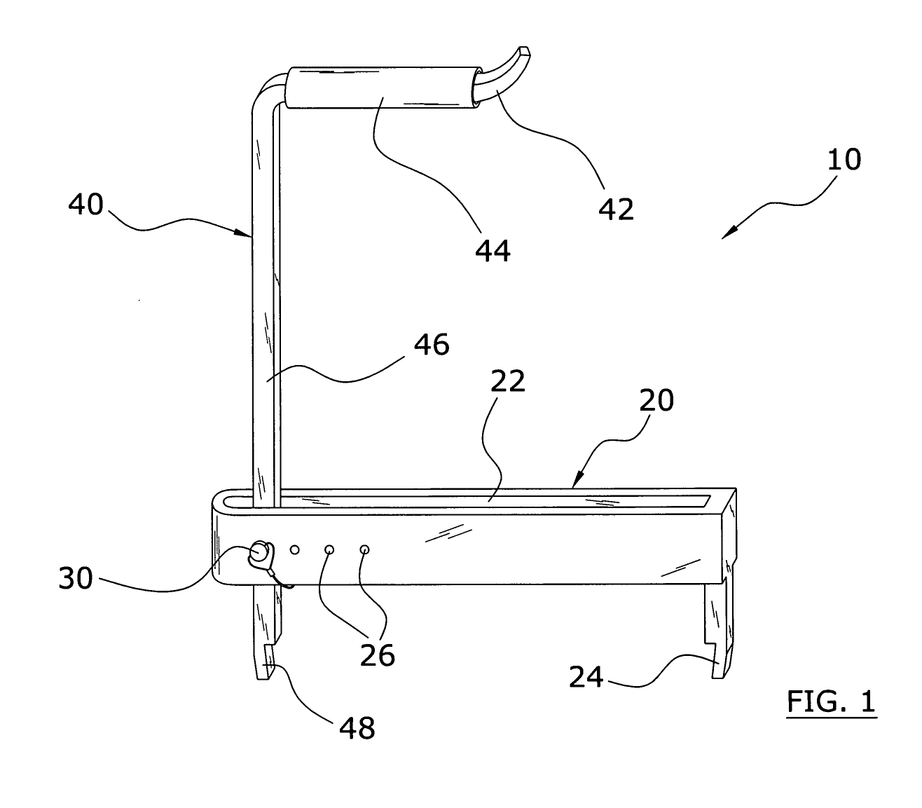

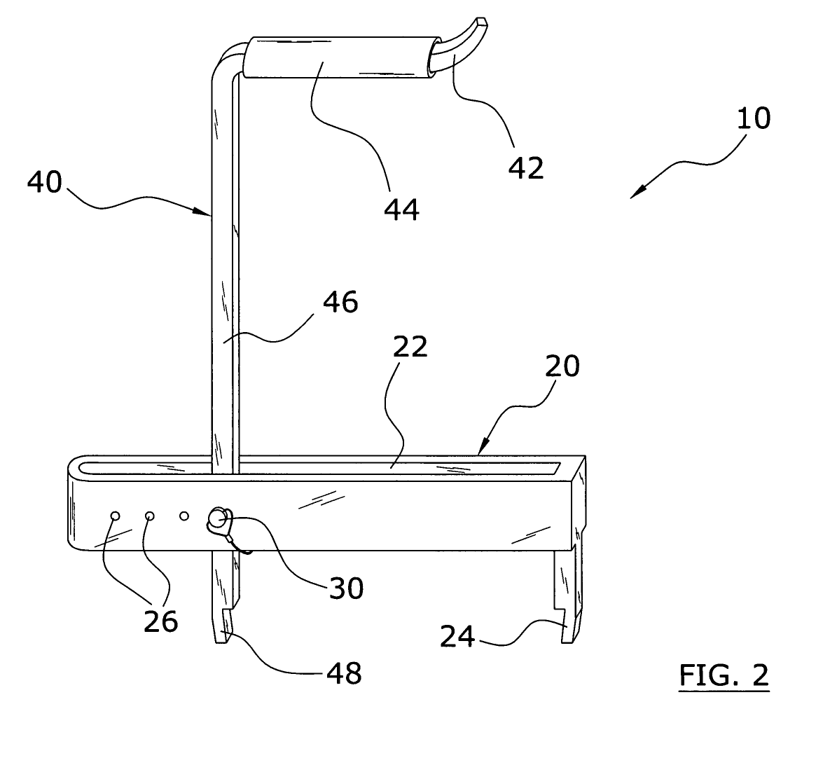

Turning now descriptively to the drawings, in which similar reference characters denote similar elements throughout the several views, FIGS. 1 through 9 illustrate a valve cap removal system 10, which comprises a base 20, a fixed jaw 24 extending from the base 20, a lever member 40 pivotally attached to the base 20, and a lower jaw 48 extending from the lever member 40. The fixed jaw 24 and the lower jaw 48 are formed to fit within pivot holes 14 in the perimeter of a utility valve cap 12. When the lever member 40 is manipulated, the lower jaw 48 is drawn towards the fixed jaw 24 thereby engaging the valve cap 12 between thereof. The continued upward movement of the lever member 40 results in the valve caps 12 being removed from a valve housing 16.

B. Base

As illustrated in FIGS. 1 through 6 of the drawings, the base 20 preferably includes a slot 22 that pivotally receives the lever member 40. The base 20 may be comprised of a solid or hollow structure without a slot 22 with the lever member 40 pivotally attached to a side of the base 20 (not shown). The base 20 is also preferably comprised of an elongated structure to provide a sufficient span over a valve cap 12 to be removed.

The base 20 preferably includes a plurality of attachment apertures 26 as shown in FIGS. 1 through 9 of the drawings. The lever member 40 preferably includes a pivot aperture 47 that is aligned with one set of the attachment apertures 26 depending upon the size of the valve cover to be removed.

A pin is removably extendable through a set of the attachment apertures 26 and the pivot aperture 47 for pivotally securing the lever member 40 in a desired position depending upon a size of the valve cover to be removed as shown in FIGS. 1 through 4 of the drawings. The pin is preferably comprised of a quick coupler structure for allowing efficient disassembly of the present invention and realignment of the lever member 40.

C. Fixed Jaw

A fixed jaw 24 extends from the base 20 as illustrated in FIGS. 1 through 9 of the drawings. The fixed jaw 24 preferably extends from a first end of the base 20.

The fixed jaw 24 is preferably non-adjustable, however an adjustable jaw may be utilized in place of the fixed jaw 24 to accommodate various sizes of valve covers. The fixed jaw 24 may have various structures capable of engaging an outer perimeter of a valve cover within one of the pivot holes 14.

D. Lever Member

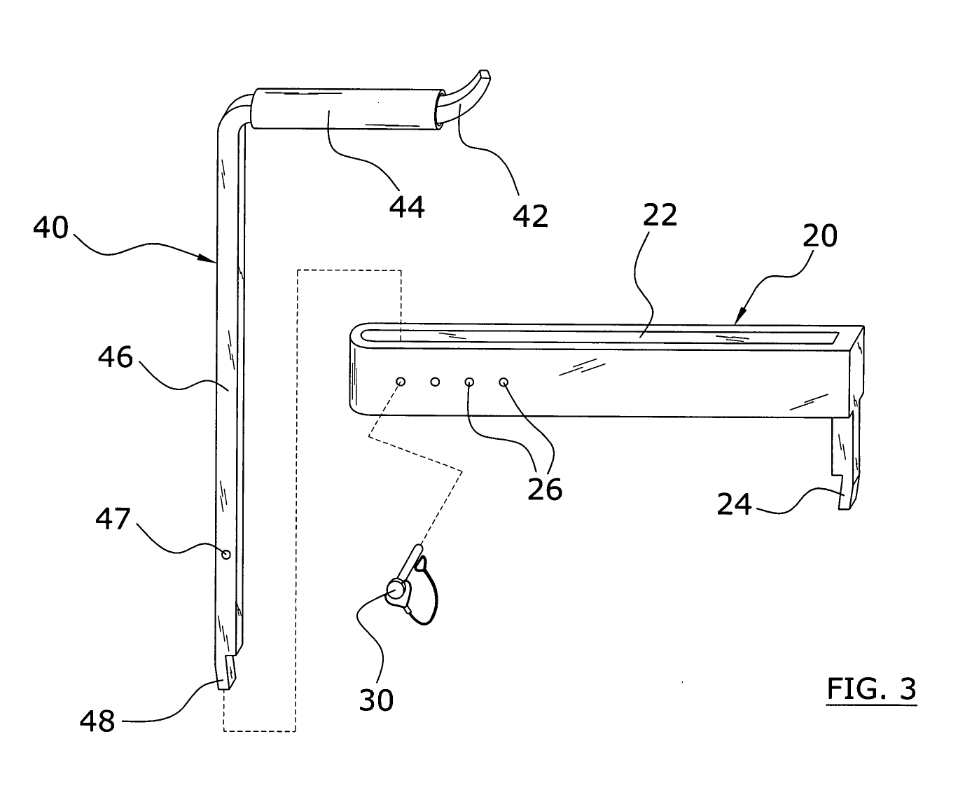

The lever member 40 is pivotally attached within the slot 22 of the base 20 as shown in FIGS. 1 through 9 of the drawings. The lever member 40 is preferably comprised of a shaft 46 pivotally attached to the base 20 and a handle member 42 extending at an angle from the shaft 46 as shown in FIGS. 1 through 4 of the drawings. The lower jaw 48 extends from an end of the shaft 46 opposite of the shaft 46 as best illustrated in FIG. 3 of the drawings.

As best illustrated in FIGS. 1, 2 and 4 of the drawings, the handle member 42 preferably extends inwardly such that lifting upon the handle member 42 causes the lower jaw 48 to pivot inwardly. In addition, a gripping 44 may be attached to the handle member 42 to assist in the grasping of the handle member 42.

E. Lower Jaw

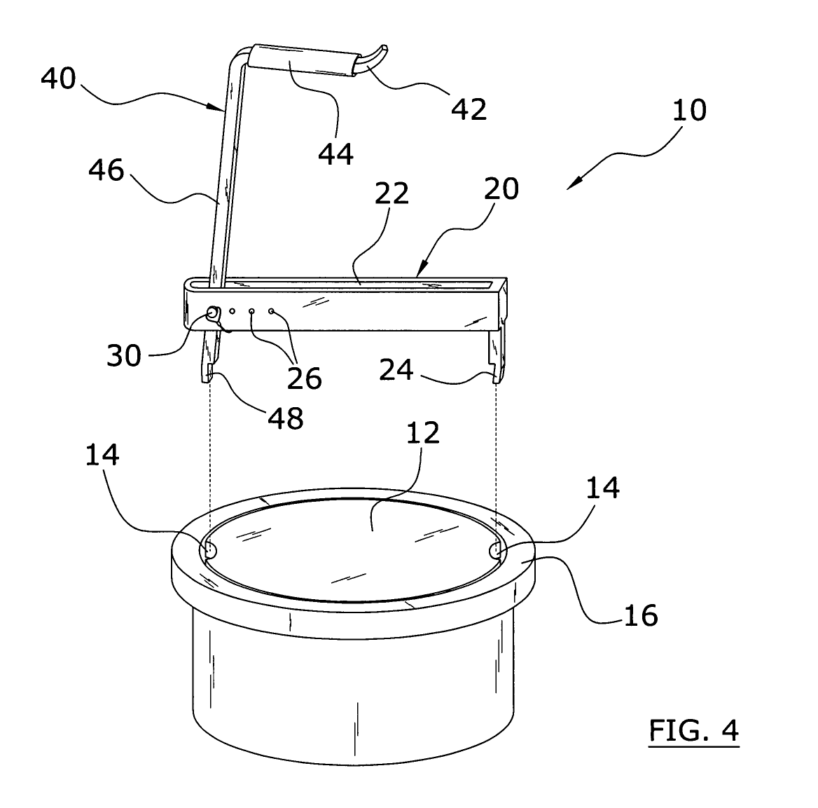

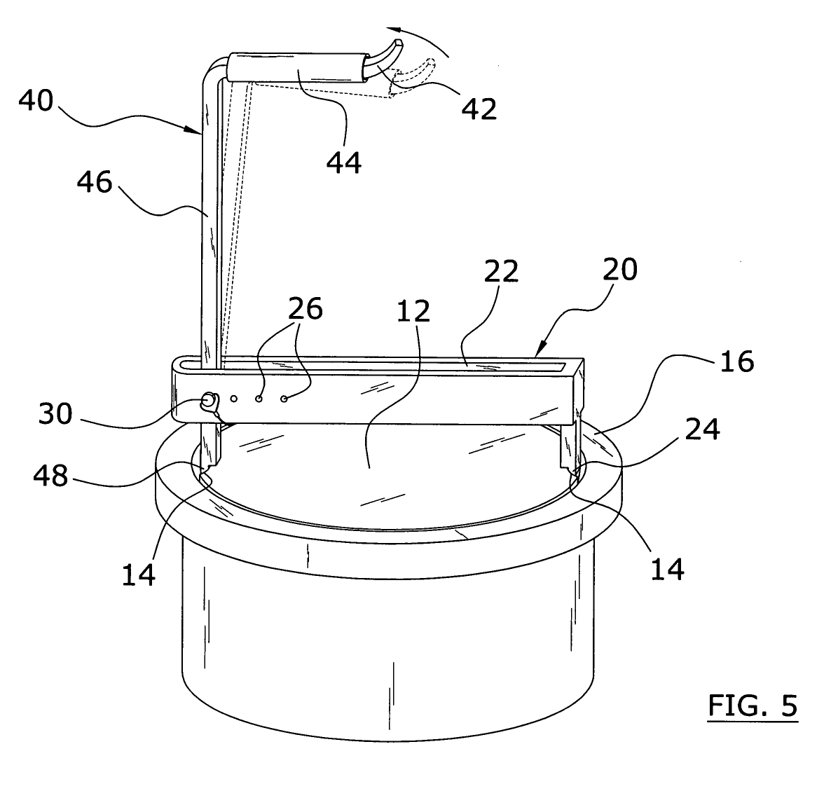

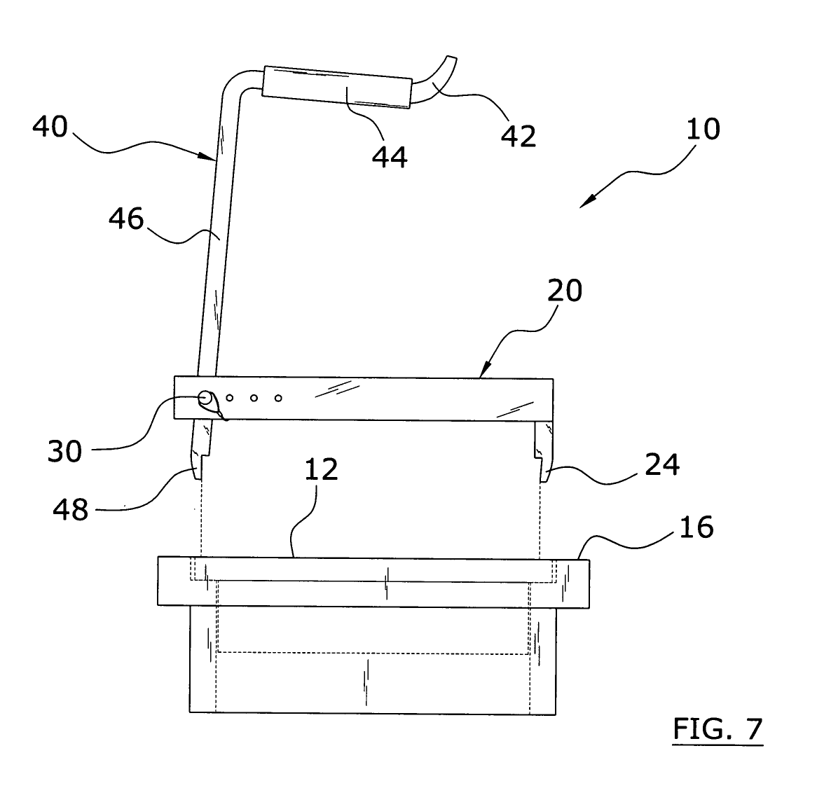

The lower jaw 48 extends from the lever member 40 as shown in FIGS. 1 through 4 of the drawings. The fixed jaw 24 and the lower jaw 48 are formed to fit within pivot holes 14 in a perimeter of a utility valve cap 12 as illustrated in FIGS. 4 and 5 of the drawings. The fixed jaw 24 is in opposition to the lower jaw 48 as best illustrated in FIG. 7 of the drawings.

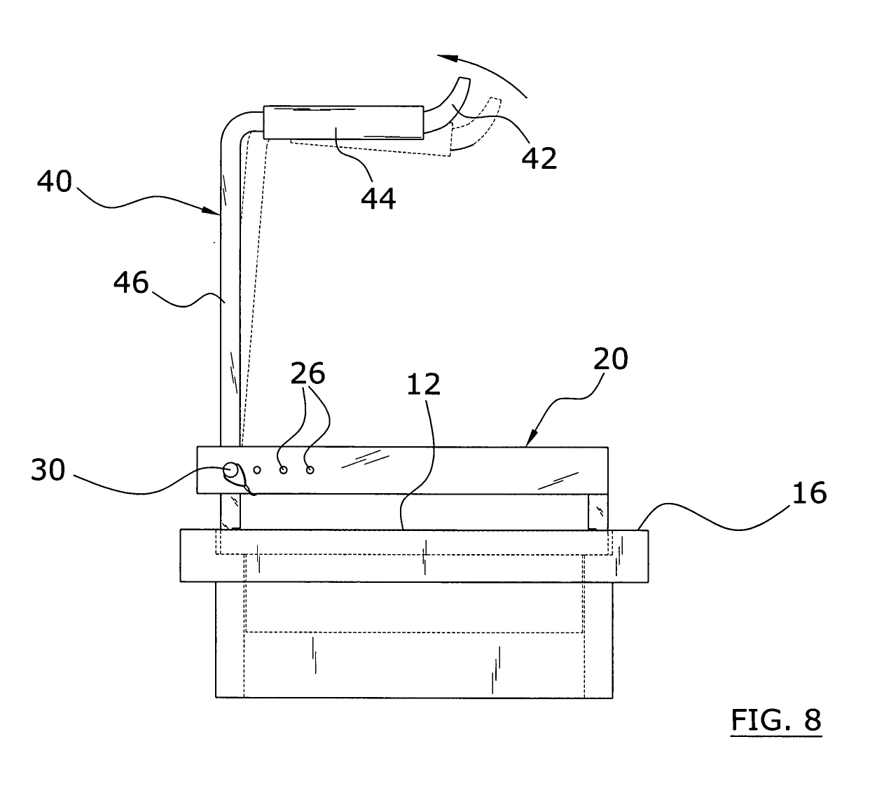

When the lever member 40 is manipulated upward, the lower jaw 48 is drawn towards the fixed jaw 24 thereby engaging the valve cap 12 between thereof as illustrated in FIGS. 5 and 8 of the drawings. The lower jaw 48 and the fixed jaw 24 preferably extend inwardly at a downward angle.

F. Operation of Invention

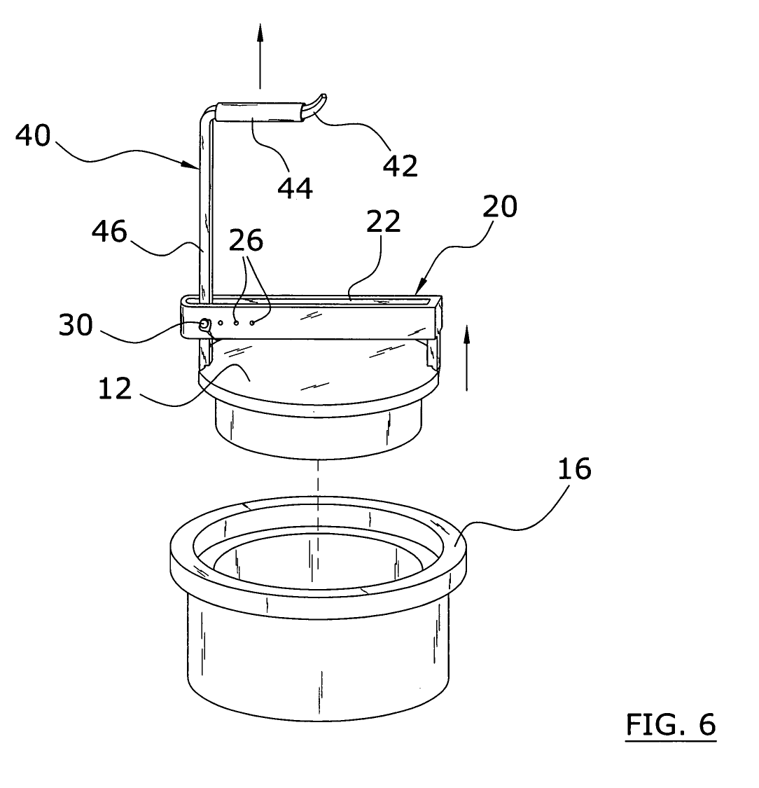

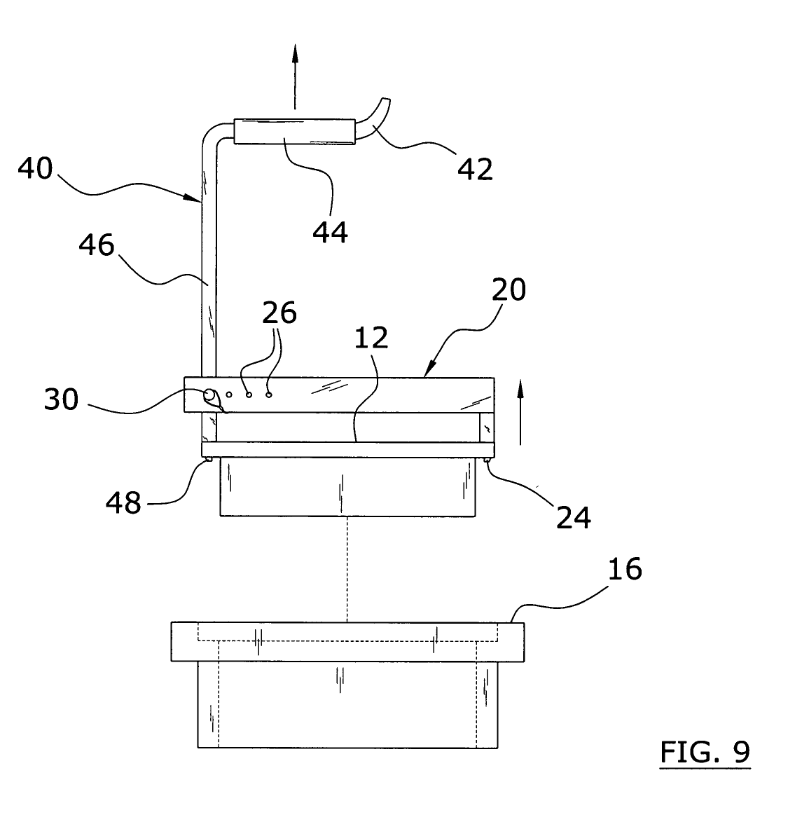

In use, the user positions the jaws 24, 48 into the pivot hole of a valve cap 12 as shown in FIGS. 4, 5 and 8 of the drawings. After the jaws 24, 48 are properly positioned, the user then grasps the handle member 42 of the lever member 40 and lifts upward. As the user lifts upward on the handle member 42, the lever member 40 pivots with respect to the base 20 thereby causing the lower jaw 48 to move inwardly towards the perimeter of the valve cover to engage the same. The inward movement of the lower jaw 48 squeezes the valve cover between the lower jaw 48 and the fixed jaw 24 as illustrated in FIGS. 5 and 8 of the drawings. The user continues to lift upwardly on the handle member 42 thereby causing the valve cap 12 to be removed from the housing 16 as shown in FIGS. 6 and 9 of the drawings. The valve cap 12 remains catchably and/or frictionally engaged between the jaws 24, 48 until the valve cap 12 is positioned on a ground surface with the upward force on the handle member 42 removed.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A valve cap removal system for efficiently removing utility valve caps, comprising:
a base;
a fixed jaw extending from said base;
a lever member pivotally attached to said base; and
a lower jaw extending from said lever member, wherein said fixed jaw and said lower jaw are formed to fit within pivot holes in a perimeter of a utility valve cap;
wherein when said lever member is manipulated said lower jaw is drawn towards said fixed jaw thereby engaging said valve cap between thereof.

2. The valve cap removal system of claim 1, wherein said base includes a slot that pivotally receives said lever member.

3. The valve cap removal system of claim 2, wherein said lever member extends through said slot.

4. The valve cap removal system of claim 2, wherein said base includes a plurality of attachment apertures and wherein said lever member includes a pivot aperture, wherein a pin is removably extendable through a set of said attachment apertures and said pivot aperture for pivotally securing said lever member in a desired position depending upon a size of the valve cover to be removed.

5. The valve cap removal system of claim 1, wherein said lever member is comprised of a shaft pivotally attached to said base, and a handle member extending at an angle from said shaft, wherein said lower jaw extends from an end of said shaft opposite of said shaft.

6. The valve cap removal system of claim 5, wherein said handle member extends inwardly such that lifting upon said handle member causes said lower jaw to pivot inwardly.

7. The valve cap removal system of claim 5, including a gripping attached to said handle member.

8. The valve cap removal system of claim 1, wherein said lower jaw and said fixed jaw extend inwardly at a downward angle.

9. The valve cap removal system of claim 1, wherein said base is comprised of an elongated structure.

10. The valve cap removal system of claim 1, wherein said fixed jaw extends from a first end of said base.

11. The valve cap removal system of claim 1, wherein said fixed jaw is in opposition to said lower jaw.

12. A valve cap removal system for efficiently removing utility valve caps, comprising:
a base including a slot;
a fixed jaw extending from said base;
a lever member pivotally attached within said slot of said base, wherein said lever member is comprised of a shaft pivotally attached to said base, and a handle member extending at an angle from said shaft, wherein said lower jaw extends from an end of said shaft opposite of said shaft; and
a lower jaw extending from said lever member, wherein said fixed jaw and said lower jaw are formed to fit within pivot holes in a perimeter of a utility valve cap;
wherein said fixed jaw is in opposition to said lower jaw;
wherein when said lever member is manipulated said lower jaw is drawn towards said fixed jaw thereby engaging said valve cap between thereof.

13. The valve cap removal system of claim 12, wherein said base includes a plurality of attachment apertures and wherein said lever member includes a pivot aperture, wherein a pin is removably extendable through a set of said attachment apertures and said pivot aperture for pivotally securing said lever member in a desired position depending upon a size of the valve cover to be removed.

14. The valve cap removal system of claim 12, wherein said handle member extends inwardly such that lifting upon said handle member causes said lower jaw to pivot inwardly.

15. The valve cap removal system of claim 12, including a gripping attached to said handle member.

16. The valve cap removal system of claim 12, wherein said lower jaw and said fixed jaw extend inwardly at a downward angle.

17. The valve cap removal system of claim 12, wherein said base is comprised of an elongated structure.

18. The valve cap removal system of claim 12, wherein said fixed jaw extends from a first end of said base.
